(19) United States
(12) Patent Application Publication
(10) Pub. No.: US 2026/0165307 A1
(43) Pub. Date: Jun. 18, 2026

(54) FISHING REEL

(71) Applicant: Shimano Inc., Osaka (JP)

(72) Inventors: Takeshi IKUTA, Osaka (JP); Hiroki OOGOSE, Osaka (JP); Kohei NAKAMURA, Osaka (JP); Hirotaka Honda, Osaka (JP)

(21) Appl. No.: 19/398,573

(22) Filed: Nov. 24, 2025

(30) Foreign Application Priority Data
Dec. 16, 2024 (JP) 2024-219779

(51) Int. Cl. A01K 89/0155

(52) U.S. Cl. CPC A01K 89/0155

(57) ABSTRACT

A fishing reel is capable of adding drag force without an increase in reel size. The fishing reel includes a reel body. A handle is rotatably mounted on the reel body and a drive shaft is configured to rotate integrally with the handle. A drive gear is arranged around the drive shaft. In the fishing reel, a first drag mechanism configured to restrict relative rotation between the drive gear and the drive shaft, and a second drag mechanism is configured to restrict rotation of the drive gear relative to the reel body.

### CROSS-REFERENCE TO RELATED APPLICATIONS

This application claims priority to Japanese Patent Application No. 2024-219779, filed Dec. 16, 2024. The contents of that application are incorporated by reference herein in their entirety.

### TECHNICAL FIELD

The present invention relates to a fishing reel.

### BACKGROUND

Conventionally, a fishing reel includes a reel body, a handle rotatably mounted on the reel body, a drive shaft configured to rotate integrally with the handle, a drive gear mounted on the drive shaft, a spool shaft rotatably supported by the reel body, a spool configured to rotate integrally with the spool shaft, and a drag mechanism for restricting relative rotation between the drive shaft and the drive gear. In such configurations, the drag mechanism is incorporated in the drive gear shaft assembly (for example, see Japanese Patent No. 6649699).

### BRIEF SUMMARY

However, in fishing reels equipped with this type of drag mechanism (commonly referred to as a “star drag mechanism”), the output at the spool is reduced to a value divided by the gear ratio, resulting in a maximum drag force that is lower than that of spinning reels or lever-drag reels.

To address this issue, for example, if the number of drag assemblies on the drive gear shaft is increased to enhance the drag force, a new problem is created. The handle will be displaced farther from the reel body by the amount corresponding to the increased number of drag assemblies. As a result, the reel tends to wobble during winding with the handle, making it difficult to apply force. Furthermore, increasing drag force requires the roller clutch to withstand higher loads, which means a larger roller clutch is needed. This, in turn, makes the reel bulkier. Accordingly, there has remained room for improvement.

The claimed invention has been devised in consideration of these circumstances, with an aim of providing a fishing reel that can increase drag force while limiting an increase in reel size.
(1) According to a first aspect of the claimed invention, a fishing reel includes: a reel body; a handle rotatably mounted on the reel body; a drive shaft configured to rotate integrally with the handle; a drive gear arranged around the drive shaft; a first drag mechanism configured to restrict relative rotation between the drive gear and the drive shaft; and a second drag mechanism configured to restrict rotation of the drive gear relative to the reel body.

According to the first aspect of the fishing reel of the claimed invention, the drag force generated by the second drag mechanism is added to that of the first drag mechanism, enabling the reel to be used with higher drag force.
(2) In a second aspect of the claimed invention, in the fishing reel according to the first aspect, the second drag mechanism preferably includes a drag gear configured to engage with the drive gear, and a drag plate disposed between the drag gear and the reel body and configured to restrict rotation of the drive gear relative to the reel body.

In this case, the second drag mechanism includes a drag gear configured to engage with the drive gear and a drag plate configured to restrict rotation of the drive gear relative to the reel body. As a result, the drag force by the second drag mechanism can be applied more effectively.
(3) In a third aspect of the claimed invention, in the fishing reel according to the second aspect, the second drag mechanism preferably includes an adjustment mechanism configured to adjust either frictional force between the drag gear and the drag plate or frictional force between the reel body and the drag plate.

In this case, the second drag mechanism includes an adjustment mechanism configured to adjust either the frictional force between the drag gear and the drag plate or the frictional force between the reel body and the drag plate. As a result, the drag force by the second drag mechanism is adjustable as required.
(4) In a fourth aspect of the claimed invention, in the fishing reel according to the second or third aspect, the second drag mechanism preferably includes a one-way clutch that is configured to transmit rotation of the drag gear in a line-winding direction to the drag plate and not to transmit rotation of the drag gear in a line-releasing direction to the drag plate.

In this case, the second drag mechanism includes a one-way clutch that is configured to transmit rotation of the drag gear in a line-winding direction to the drag plate and not to transmit rotation of the drag gear in a line-releasing direction to the drag plate. With this configuration, rotation of the drag gear in the line-winding direction is transmitted to the drag plate. In this state, no frictional force is generated between the drag gear and the drag plate, so that line retrieval is not affected by the drag force. On the other hand, rotation of the drag gear in the line-releasing direction is not transmitted to the drag plate. In this state, frictional force can be generated between the drag gear and the drag plate, so that drag force is applied during line-releasing.
(5) In a fifth aspect of the claimed invention, in the fishing reel according to any one of the first to third aspects, the second drag mechanism is preferably disposed in the downward direction relative to the drive gear.

In this case, the second drag mechanism is located below the drive gear, so that the user can operate the fishing reel without being affected by the line-winding operation or the line-releasing operation.
(6) In a sixth aspect of the claimed invention, in the fishing reel according to any one of the first to third aspects, the second drag mechanism is preferably disposed in the line-releasing direction relative to the drive gear.

In this case, the second drag mechanism is located in the line-releasing direction relative to the drive gear, so that the user can operate the fishing reel without being affected by the line-winding operation or the line-releasing operation.
(7) In a seventh aspect of the claimed invention, in the fishing reel according to any one of the first to third aspects, the fishing reel preferably includes a plurality of the second drag mechanisms.

In this case, a plurality of the second drag mechanisms enables application of their drag forces in addition to that of the first drag mechanism, allowing the reel to be used with a higher drag force.

According to the fishing reel of the claimed invention, the drag force can be increased while limiting an increase in reel size.

### BRIEF DESCRIPTION OF THE DRAWINGS

FIG. 1 is a perspective view of a dual-bearing reel according to one embodiment.

FIG. 2 is a sectional view of the dual-bearing reel.

FIG. 3 is a side view of the dual-bearing reel with the cover member removed.

FIG. 4 is a front view of the dual-bearing reel with the cover member removed.

FIG. 5 is another sectional view of the dual-bearing reel.

FIG. 6 is an exploded perspective view of part of the second drag mechanism.

FIG. 7 is a front view of the second drag mechanism.

FIG. 8 is a side view of the second drag mechanism.

FIG. 9 is an enlarged view of the second drag mechanism.

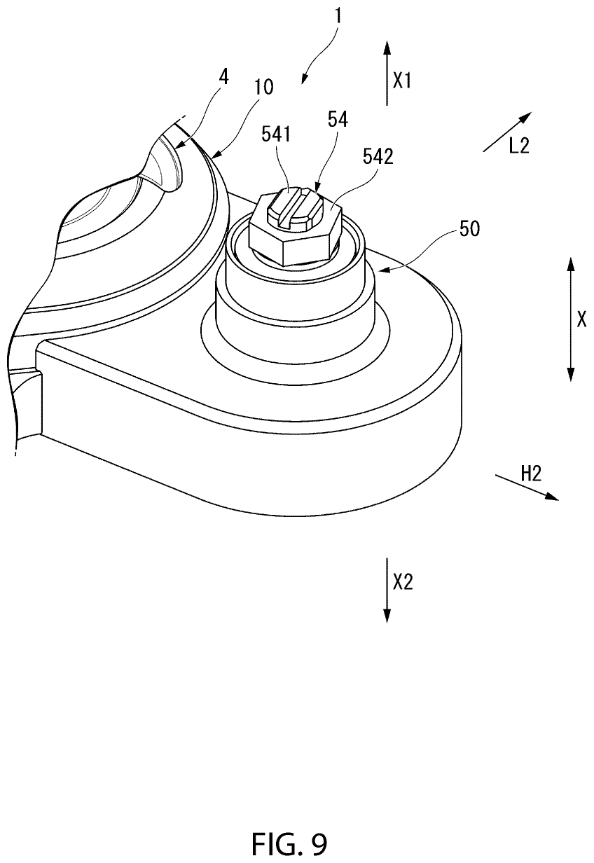

FIG. 10 is a front view of a dual-bearing reel according to a first modification, with the cover member removed.

FIG. 11 is a front view of a dual-bearing reel according to a second modification, with the cover member removed.

FIG. 12 is a front view of a dual-bearing reel according to a third modification, with the cover member removed.

### DETAILED DESCRIPTION

Embodiments of a fishing reel according to the claimed invention will be described below with reference to the drawings. It should be noted that in the drawings, the scale of each component may be adjusted as necessary so that each component can be visibly recognized. In the present embodiment, a dual-bearing fishing reel is described as an example of the fishing reel.

### Overall Configuration

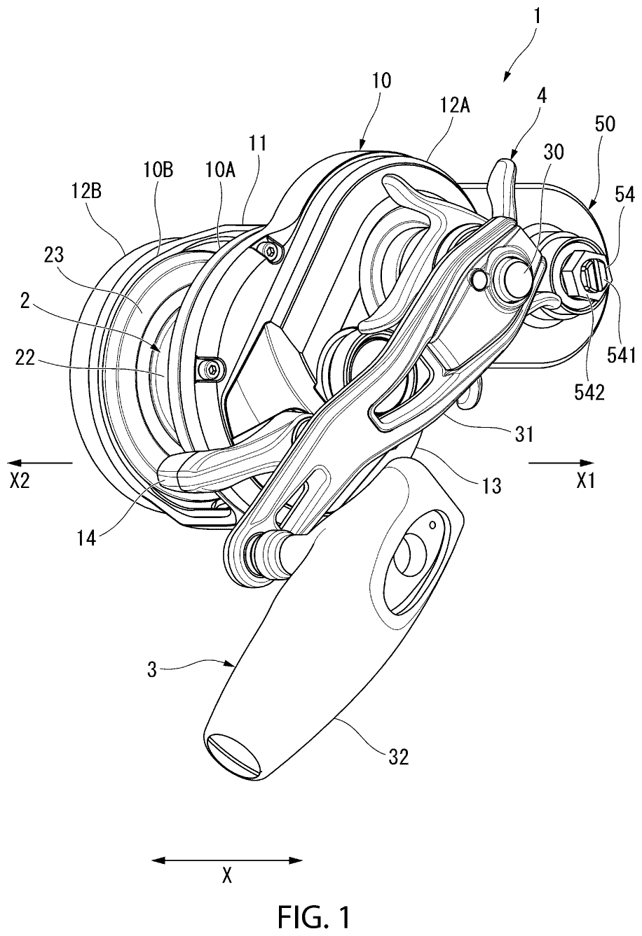

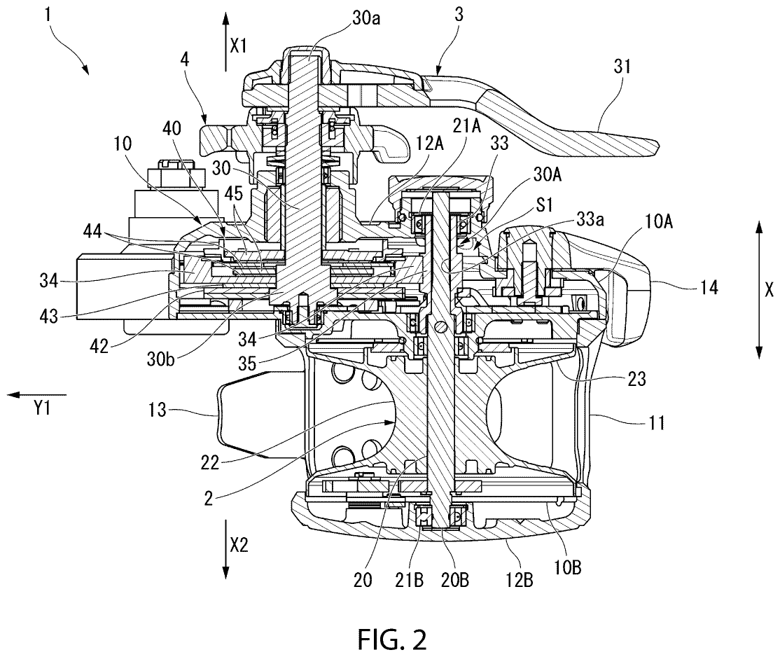

As illustrated in FIGS. 1 and 2, the fishing reel of the present embodiment is implemented as a dual-bearing reel 1 capable of winding a fishing line.

The dual-bearing reel 1 includes a reel body 10, a spool shaft 20 rotatably mounted at the center of the reel body 10, a spool 2 non-rotatably supported on the spool shaft 20, a handle 3 disposed on a side of the reel body 10, and a drag adjustment unit 4 for drag adjustment that is arranged on a side of the handle 3 toward the reel body 10.

As illustrated in FIG. 2, the reel body 10 of the dual-bearing reel 1 transmits rotation of the handle 3 to the spool 2 in a direction in which a fishing line is retrieved via a drive gear 34 and a pinion gear 35. The reel body 10 also includes a first drag mechanism 40 configured to apply drag force to the rotation of the spool 2 in a direction in which the fishing line is dispensed.

### Reel Body

The reel body 10 includes a pair of right and left side frames 10A and 10B made of metal, a plurality of connecting frames 11 connecting the right and left side frames 10A and 10B at the front, rear, and lower portions, and cover members 12A and 12B covering the outer sides of the right and left side frames 10A and 10B, respectively.

A rod mounting unit 13 configured to attach the dual-bearing reel 1 to a fishing rod is integrally formed on the connecting frame 11 positioned at the lower side. The right-side frame 10A, the left-side frame 10B, and the connecting frames 11 are integrally formed by cutting and machining of metal.

As illustrated in FIG. 1, the right cover member 12A covers the outside of the right-side frame 10A. The right-side frame 10A and the left-side frame 10B have an opening through which the spool 2 can pass. The left cover member 12B rotatably supports the left end of the spool shaft 20.

As illustrated in FIG. 2, a rotation transmission mechanism 30A is configured to transmit the rotation of the handle 3 to the spool 2 and is disposed in a first accommodation space S1 on the inner side of the right-side frame 10A. In addition, the first accommodation space S1 also houses a clutch control mechanism (not shown) configured to control a clutch mechanism in response to operation of the clutch operation unit 14 illustrated in FIG. 1. A first drag mechanism 40 described later is housed in the first accommodation space S1 as well.

### Spool Shaft

As illustrated in FIG. 2, the spool shaft 20 is rotatably supported by the right cover member 12A and the left cover member 12B. The spool shaft 20 is rotatably supported by two bearings, a first bearing 21A and a second bearing 21B, which are arranged on the outer circumferential surface. The spool shaft 20 is fixed integrally to the spool 2.

### Spool

As illustrated in FIG. 2, the spool 2 includes a spool barrel portion 22 and a pair of flanges 23 integrally formed at both ends of the spool barrel portion 22.

### Handle

As illustrated in FIGS. 1 and 2, a drive shaft 30, which serves as the rotation axis of the handle 3, is disposed in front of and parallel to the spool shaft 20. The handle 3 is fixed to the projecting end of the drive shaft 30 and rotates integrally with the drive shaft 30. The drive shaft 30 is rotatably supported by the reel body 10. The handle 3 includes a handle arm 31 extending in a direction intersecting the drive shaft 30, and a handle grip 32 rotatably mounted at the distal end of the handle arm 31. The handle arm 31 is a plate metal member and has a non-circular through-hole located at the proximal end thereof, through which the drive shaft 30 is rotatably integrally mounted.

### Rotation Transmission Mechanism

The rotation transmission mechanism 30A includes a mechanism configured to transmit a first rotation in the line-winding direction of the handle 3 to the spool 2, and a clutch mechanism configured to switch on and off the transmission of the first rotation in the line-winding direction from the spool 2 toward the handle 3.

The rotation transmission mechanism 30A includes a pinion gear shaft 33 detachably connected to the spool shaft 20, a drive shaft 30 to which the handle 3 is fixed, a drive gear 34 connected to the drive shaft 30, and a pinion gear 35 mounted to the pinion gear shaft 33 to mesh with the drive gear 34.

The pinion gear shaft 33 is externally fitted onto the spool shaft 20 and engages with the spool shaft 20 of the spool 2. The spool shaft 20 is inserted through a through-hole 33a of the pinion gear shaft 33. The pinion gear shaft 33 is axially movable forward and backward relative to the spool shaft 20 by an on/off switching operation of the clutch mechanism, so that the pinion gear shaft 33 can be connected with or disconnected from the spool shaft 20 by the movement in the axial direction. In the connected state, the pinion gear shaft 33 rotates integrally with the spool shaft 20. That is, rotation of the handle 3 is transmitted via the rotation transmission mechanism 30A, and the spool 2 is caused to rotate in the line-winding direction.

The drive shaft 30 is disposed inside the right-side frame 10A. The drive shaft 30 extends in the left-right direction and passes through the right cover member 12A in the axial direction. At the projecting end of the drive shaft 30, the drag adjustment unit 4 and the handle 3 are mounted. The drive shaft 30 corresponds to a handle shaft and is arranged in the left-right direction, that is, parallel to the axial direction of the spool 2.

The drive shaft 30 is connected to the handle 3 and is rotatably supported with respect to the right-side frame 10A. The drive shaft 30 has a drive gear 34 mounted thereto. In addition, drag washers and flat washers are also mounted to the drive shaft 30. The washers, composed of multiple thin metal plates, are stacked in the axial direction to constitute the first drag mechanism 40.

The drive gear 34 is connected such that it rotates integrally in the leftward direction X2 relative to the drive shaft 30 via the pinion gear 35 when the fishing line is pulled in the line-releasing direction with a force equal to or less than the drag force. When the fishing line is pulled in the line-releasing direction with a force exceeding the drag force, the drive shaft 30 is allowed to relatively rotate via the pinion gear 35. The drive gear 34 has gear teeth on its outer circumference that mesh with the pinion gear 35.

The pinion gear 35 meshes with the drive gear 34 via the gear teeth arranged on its outer circumference.

During manual winding of the dual-bearing reel 1 configured as described above, with the clutch being connected, the first rotation of the handle 3 in the line-winding direction is transmitted to the spool 2 in the following sequence: the handle 3, drive shaft 30, first drag mechanism 40, drive gear 34, pinion gear 35, pinion gear shaft 33, and spool 2. At this time, the rotational power is transmitted from the handle 3 to the spool 2 by the frictional force generated by the drag washers and other components constituting the first drag mechanism 40, thereby providing drag performance.

The dual-bearing reel 1 includes, as a drag mechanism, the first drag mechanism 40 configured to restrict relative rotation between the drive shaft 30 and the drive gear 34, and a second drag mechanism 50 configured to restrict rotation of the drive gear 34 relative to the reel body 10.

### First Drag Mechanism

As illustrated in FIG. 2, the first drag mechanism 40 includes a stopper gear 42, a first drag washer 43, and the drive gear 34, which are arranged in this order in an axially stacked state from the base end 30b of the drive shaft 30 in the leftward direction X2 toward the distal end 30a of the drive shaft 30 in the rightward direction X1. Furthermore, to the right of the drive gear 34 in the direction X1, a plurality of second drag washers 44 and a plurality of flat washers 45 are arranged in an axially stacked state. The stopper gear 42 and the flat washers 45 are non-rotatably arranged to the drive shaft 30.

In the first drag mechanism 40, the rotational power is transmitted from the handle 3 to the spool 2 by the frictional force generated on both sliding surfaces of each drag washer 43 and 44, thereby providing drag performance. In the dual-bearing reel 1, when the clutch is connected, the rotational power is transmitted from the handle 3 to the spool 2 in the following sequence: the handle 3, drive shaft 30, drag washers 43 and 44, drive gear 34, pinion gear 35, pinion gear shaft 33, spool shaft 20, and spool 2.

When the fishing line is strongly pulled in the line-releasing direction, a force exceeding the drag force is applied to the drive gear 34 and is applied to the spool 2, pinion gear 35, and drive gear 34 in this sequence. At this time, slipping occurs between the drive gear 34, drag washers 43 and 44, stopper gear 42, and flat washers 45, which allows the fishing line to be dispensed.

### Second Drag Mechanism

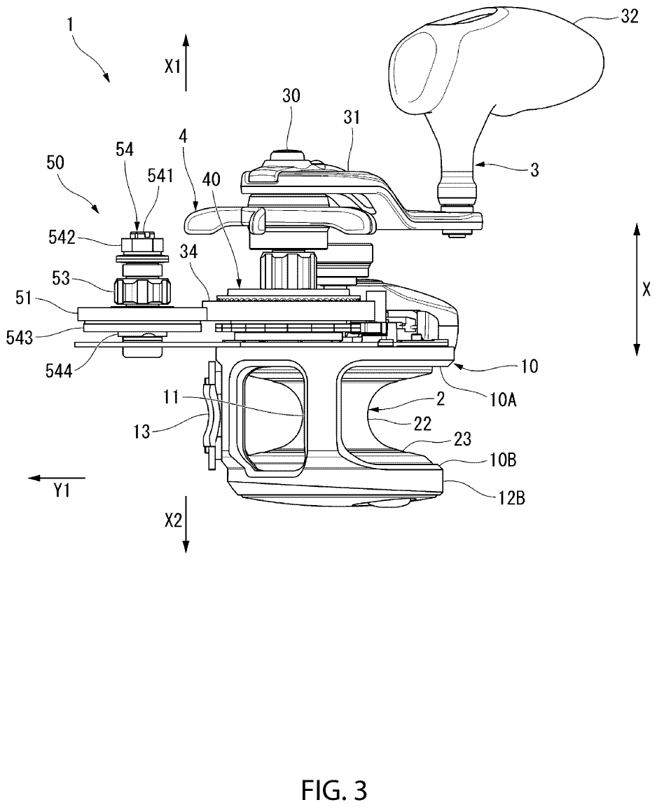

As illustrated in FIGS. 3 to 5, the second drag mechanism 50 is configured to supplement the drag force generated by the first drag mechanism 40 by adding additional drag force.

As illustrated in FIG. 3, the second drag mechanism 50 is disposed in the rightward direction X1 of the reel body 10. That is, the second drag mechanism 50 is disposed on the handle 3 side of the reel body 10.

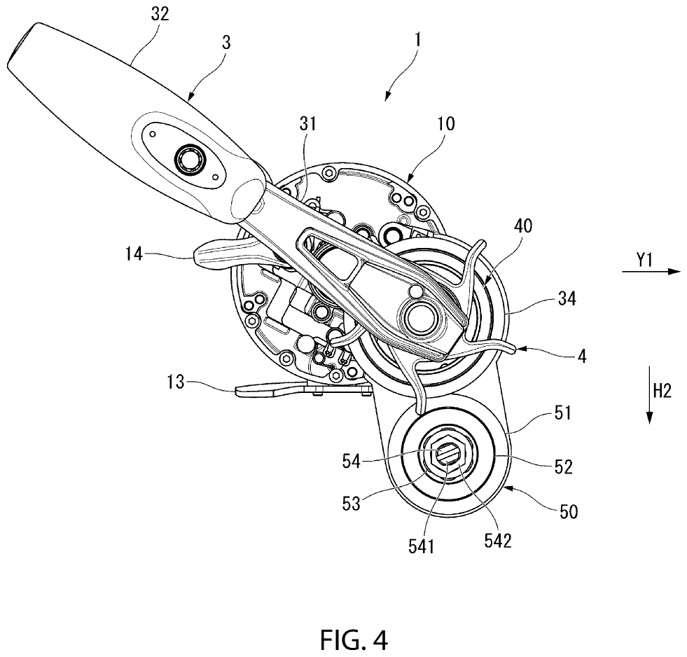

As illustrated in FIG. 4, the second drag mechanism 50 is disposed in the downward direction H2 relative to the drive gear 34. Specifically, an adjustment shaft 541, described later, is disposed at a position inclined approximately 10 degrees from directly below the drive shaft 30 when viewed in the axial direction X. The adjustment shaft 541 only needs to be disposed at a position inclined not more than approximately 15 degrees from directly below the drive shaft 30 when viewed in the axial direction X. Here, when a rod fitted with the rod mounting unit 13 is held in a horizontal state, the up-down direction is defined as the direction perpendicular to both the horizontal direction and the left-right direction. The term ‘downward direction H2’ refers to the side of the reel body 10, in the up-down direction, on which the rod mounting unit 13 is disposed.

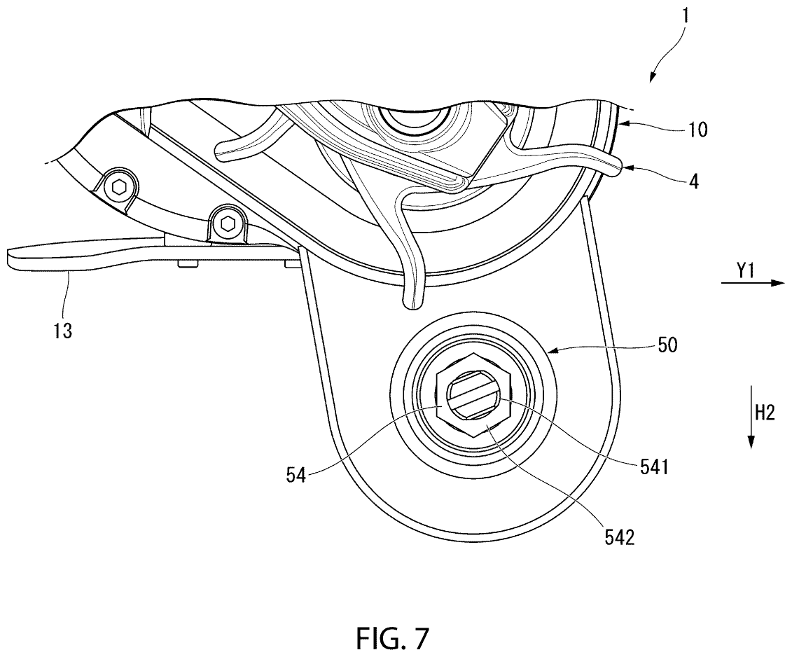

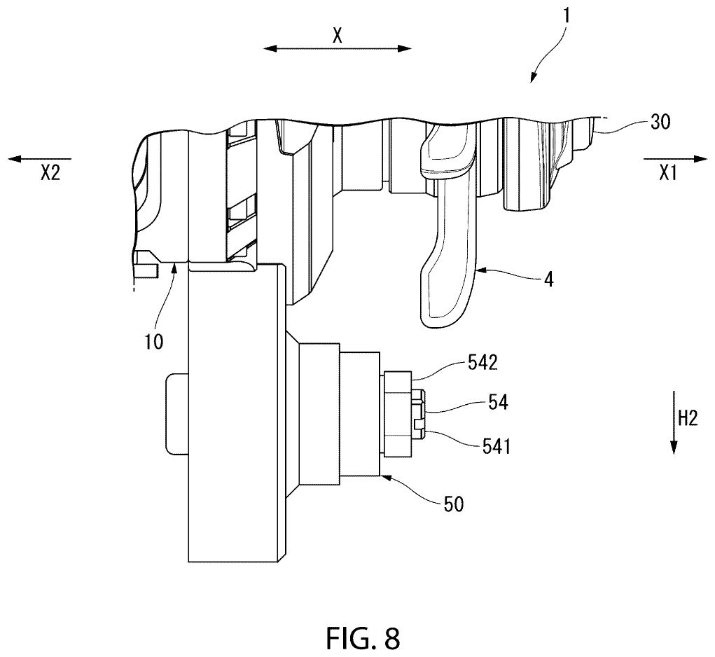

As illustrated in FIG. 7, the second drag mechanism 50 is positioned such that it does not overlap with the drag adjustment unit 4 when viewed in the axial direction X. The second drag mechanism 50 is positioned so that it does not interfere in the radial direction with the drag adjustment unit 4 when the drag adjustment unit 4 rotates. As illustrated in FIG. 8, the second drag mechanism 50 is positioned such that it does not overlap with the drag adjustment unit 4 when viewed in the radial direction. The second drag mechanism 50 is disposed at a position where it does not interfere in the axial direction X with the drag adjustment unit 4 when the drag adjustment unit 4 rotates.

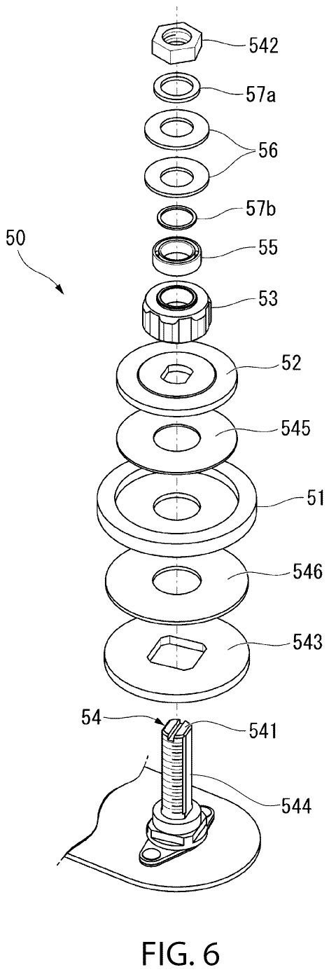

As illustrated in FIG. 6, the second drag mechanism 50 includes a drag gear 51, a third drag washer 52, a drag plate 543, a one-way clutch 53, a second drag adjustment mechanism (adjustment mechanism) 54, a first friction plate 545 disposed between the drag gear 51 and the third drag washer 52, and a second friction plate 546 disposed between the drag gear 51 and the drag plate 543. In addition, a bearing 55, a spring washer assembly 56, and washers 57a and 57b between them are arranged between a nut 542 and the one-way clutch 53.

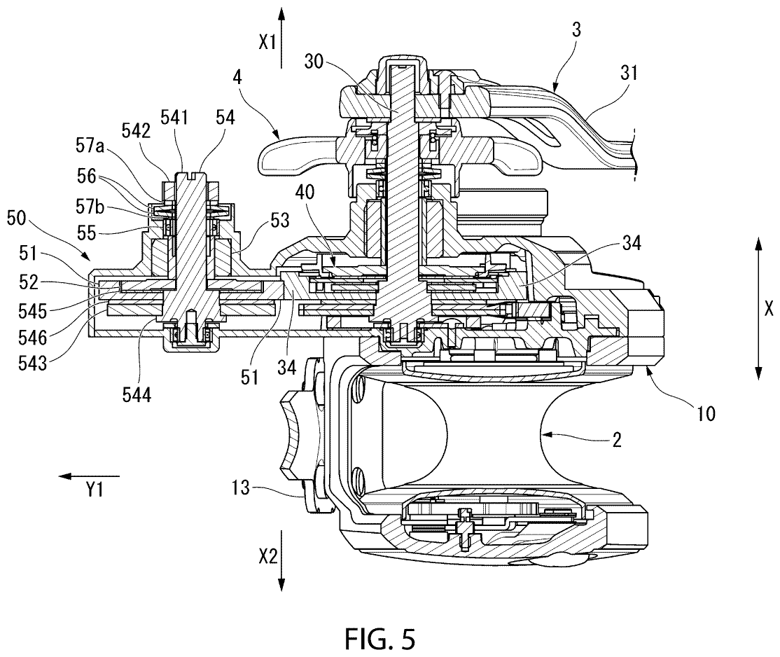

As illustrated in FIG. 5, the drag gear 51 is a gear that engages with the drive gear 34. As illustrated in FIG. 6, the drag gear 51 is a disk-shaped gear. The drag gear 51 rotates about the adjustment shaft 541, which is formed in a cylindrical shape, with the axial direction X serving as the rotational axis. The drag gear 51 rotates integrally with the drive gear 34.

The drag plate 543 is a member configured to restrict rotation of the drive gear 34 relative to the reel body 10. As illustrated in FIG. 5, the drag plate 543 is disposed between the drag gear 51 and the reel body 10 in the axial direction X. As illustrated in FIG. 6, the drag plate 543 is a disk-shaped control disk. The drag plate 543 engages with an engagement portion 544 of the adjustment shaft 541. The engagement portion 544 comprises the four flat surfaces of the adjustment shaft 541. The drag plate 543 rotates integrally with the adjustment shaft 541 about the adjustment shaft 541, which is formed in a cylindrical shape, with the axial direction X serving as the rotational axis.

The one-way clutch 53 is a member configured to permit rotation of the drag gear 51 in the line-winding direction and to prevent rotation of the drag gear 51 in the line-releasing direction. As illustrated in FIG. 5, the one-way clutch 53 is disposed between the drag plate 543 and the reel body 10 in the axial direction X. The one-way clutch 53 is a one-way bearing. The inner ring of the one-way clutch 53 is fixed to the adjustment shaft 541 so as to be rotatable relative thereto. When the drag plate 543 is subjected to a force to rotate in the line-winding direction, the one-way clutch 53 does not restrict the rotation of the drag plate 543. When the drag plate 543 is subjected to a force to rotate in the line-releasing direction, the one-way clutch 53 restricts the rotation of the drag plate 543. The one-way clutch 53 is a member configured to transmit the rotation of the drag gear 51 in the line-winding direction to the drag plate 543, and not to transmit the rotation of the drag gear 51 in the line-releasing direction to the drag plate 543.

The second drag adjustment mechanism 54 is a member configured to adjust the frictional force between the third drag washer 52, the drag gear 51, and the drag plate 543. As illustrated in FIG. 6, the second drag adjustment mechanism 54 includes a cylindrical adjustment shaft 541. As illustrated in FIG. 5, the adjustment shaft 541 is configured to press the drag gear 51 and the drag plate 543 in the axial direction X. When the adjustment shaft 541 is rotated and adjusted relative to a nut 542, the nut 542 axially moves relative to the adjustment shaft 541, thereby enabling adjustment of the frictional force between the third drag washer 52, the drag gear 51, and the drag plate 543.

The adjustment shaft 541 is formed with a threaded portion on its outer circumference. As illustrated in FIG. 6, a slotted groove is formed on the surface of the adjustment shaft 541 in the rightward direction X1, allowing the adjustment shaft 541 to be rotated by a jig or the like. As illustrated in FIG. 6, a nut 542 is mounted on the adjustment shaft 541 in the rightward direction X1. When the nut 542 is prevented from rotating together with the adjustment shaft 541 and the adjustment shaft 541 is rotated, the nut 542 moves relatively in the axial direction X.

Further, when the adjustment shaft 541 is prevented from rotating by a jig or the like and the nut 542 is rotated, the nut 542 likewise moves relatively in the axial direction X with respect to the adjustment shaft 541.

As illustrated in FIG. 6, the second drag mechanism 50 includes a first friction plate 545. The first friction plate 545 is a disk-shaped member composed of a carbon washer or the like. As illustrated in FIGS. 5 and 6, the first friction plate 545 is a member disposed between the drag gear 51 and the third drag washer 52 and configured to adjust the frictional force as the nut 542 moves relative to the adjustment shaft 541 in the axial direction X.

As illustrated in FIG. 6, the second drag mechanism 50 further includes a second friction plate 546. The second friction plate 546 is a disk-shaped member composed of a carbon washer or the like. As illustrated in FIGS. 5 and 6, the second friction plate 546 is a member disposed between the drag gear 51 and the drag plate 543 and configured to adjust the frictional force as the nut 542 moves relative to the adjustment shaft 541 in the axial direction X.

### Operation of the Second Drag Mechanism 50

Next, the operation of the second drag mechanism 50 will be described.

In the dual-bearing reel 1, when the fishing line is retrieved with the clutch engaged, the rotational power from the handle 3 is transmitted to the drag gear 51 in sequence through the handle 3, drive shaft 30, drive gear 34, and drag gear 51. At this time, the drag gear 51 rotates in the line-winding direction. As the drag gear 51 rotates in the line-winding direction, the drag plate 543 rotates together with the drag gear 51 in the line-winding direction. In this state, the one-way clutch 53 does not restrict the rotation of the drag plate 543 in the line-winding direction. Therefore, when the fishing line is retrieved, the drag force by the second drag mechanism does not affect the winding operation.

In the dual-bearing reel 1, when the fishing line is pulled in the line-releasing direction with the clutch engaged, the rotational force is transmitted in sequence through the spool 2, pinion gear shaft 33, pinion gear 35, drive gear 34, and drag gear 51. In this case, the drag performance of the second drag mechanism 50 is exhibited by the frictional force between the drag gear 51 and the drag plate 543. At this time, friction is generated between the drag gear 51 and the drag plate 543, and the drag gear 51 applies a force to rotate the drag plate 543 in the line-releasing direction. Since the drag plate 543 is restricted from rotating in the line-releasing direction by the one-way clutch 53, the drag plate 543 does not rotate. Therefore, while frictional force is applied between the drag gear 51 and the drag plate 543, the rotation of the drag gear 51 is restricted.

On the other hand, in the dual-bearing reel 1, when the fishing line is pulled strongly in the line-releasing direction with the clutch engaged, a force exceeding the drag force is applied to the drag gear 51. That is, the force acts in sequence through the spool 2, pinion gear 35, drive gear 34, and drag gear 51. At this time, slippage occurs between the drag gear 51 and the drag plate 543, allowing the fishing line to be dispensed.

According to the dual-bearing reel 1 of the claimed invention, the drag force by the second drag mechanism 50 is also applied in addition to that by the first drag mechanism 40, allowing the dual-bearing reel 1 to be used with higher drag force. Furthermore, since the drag force by the second drag mechanism 50 is always applied when the fishing line is dispensed, the user can always use the dual-bearing reel 1 in a state of high drag force.

According to the dual-bearing reel 1 of the claimed invention, since the second drag mechanism 50 includes the drag gear 51 engaged with the drive gear 34 and the drag plate 543 for restricting the rotation of the drive gear 34 relative to the reel body 10, the drag force by the second drag mechanism 50 can be applied more effectively.

According to the dual-bearing reel 1 of the claimed invention, since the second drag mechanism 50 includes the second drag adjustment mechanism 54 configured to adjust the frictional force between the drag gear 51 and the drag plate 543, the drag force by the second drag mechanism 50 can be adjusted as needed.

According to the dual-bearing reel 1 of the claimed invention, the second drag mechanism 50 includes the one-way clutch 53 configured to transmit the rotation of the drag gear 51 in the line-winding direction to the drag plate 543 and not to transmit the rotation of the drag gear 51 in the line-releasing direction to the drag plate 543. Thus, the rotation of the drag gear 51 in the line-winding direction can be transmitted to the drag plate 543. At this time, since no frictional force is generated between the drag gear 51 and the drag plate 543, the retrieving of the fishing line is not affected by the drag force. On the other hand, the rotation of the drag gear 51 in the line-releasing direction is not transmitted to the drag plate 543. In this case, frictional force can be generated between the drag gear 51 and the drag plate 543, so that drag force is applied when the fishing line is dispensed.

Further, according to the dual-bearing reel 1 of the claimed invention, since the required drag force can be divided (distributed, dispersed) between the first drag mechanism 40 and the second drag mechanism 50, each of the first drag mechanism 40 and the second drag mechanism 50 can be reduced in size. In particular, the roller clutch can be downsized, and it is also expected that the projection in the axial direction X can be reduced. Namely, the distance between the reel body 10 and the handle 3 can be reduced.

According to the dual-bearing reel 1 of the claimed invention, since the second drag mechanism 50 is located in the downward direction H2 (on the rod mounting unit side) with respect to the drive gear 34, interference by the second drag mechanism 50 with the user's operation of retrieving and dispensing the fishing line using the handle 3 can be decreased. The second drag mechanism 50 does not interfere with the handle 3, which facilitates operation of the handle 3 by the user. In addition, the length of the dual-bearing reel 1 in the front-rear direction can be reduced, making the dual-bearing reel 1 easier for the user to handle.

### Modification 1

Next, modifications of the dual-bearing reel 1 will be described.

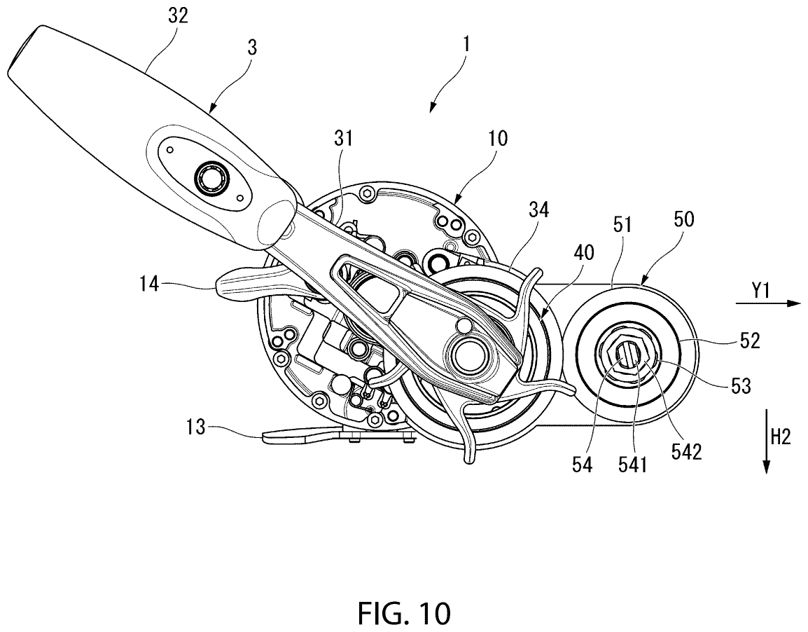

As illustrated in FIG. 10, in the dual-bearing reel 1, the second drag mechanism 50 may be disposed in the forward direction Y1 with respect to the drive gear 34. Specifically, the adjustment shaft 541 may be arranged in the forward direction Y1 with respect to the drive shaft 30. It should be noted that the adjustment shaft 541 may also be disposed at a position inclined by approximately 15 degrees or less from the forward direction Y1 when viewed from the axial direction X relative to the drive shaft 30. Here, when a rod to which the rod mounting unit 13 is attached is held horizontally, the longitudinal direction of the rod is defined as the front-rear direction. The forward direction Y1 refers to the line-releasing direction of the reel body 10 in the front-rear direction.

By disposing the second drag mechanism 50 in the forward direction Y1 with respect to the drive gear 34, interference with the user's line-winding and line-releasing operations using the handle 3 can be decreased. Since the second drag mechanism 50 does not interfere with the handle 3, the user can easily operate the handle 3. In addition, the length of the dual-bearing reel 1 in the up-down direction can be reduced, making the dual-bearing reel 1 easier for the user to handle.

### Modification 2

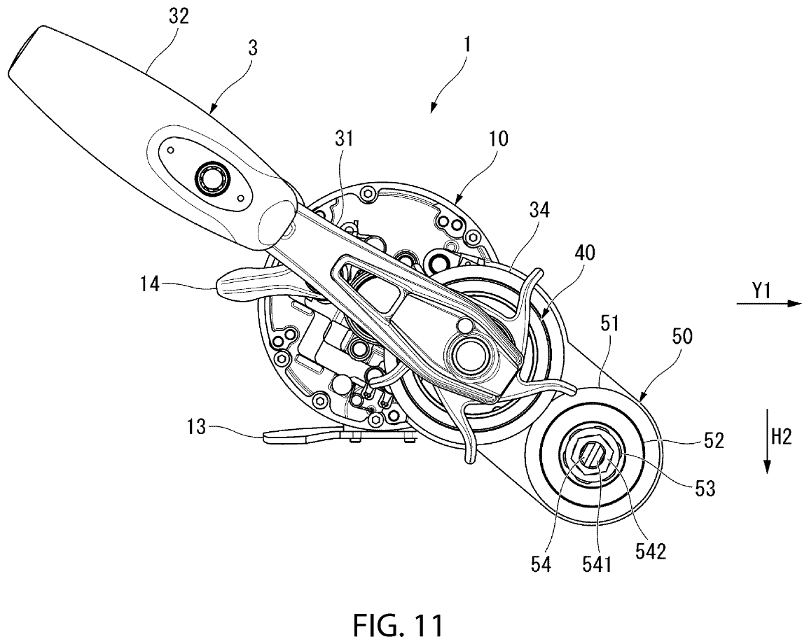

As illustrated in FIG. 11, in the dual-bearing reel 1, the second drag mechanism 50 may be disposed in the front-lower direction relative to the drive gear 34. Specifically, the adjustment shaft 541 may be arranged at a position inclined by approximately 45 degrees in the front-lower direction relative to the drive shaft 30 as viewed in the axial direction X. It should be noted that the adjustment shaft 541 may alternatively be arranged at a position inclined by 30 to 60 degrees in the front-lower direction relative to the drive shaft 30 as viewed in the axial direction X.

By disposing the second drag mechanism 50 in the front-lower direction relative to the drive gear 34, interference with the user's line-winding and line-releasing operations using the handle 3 can be decreased. Since the second drag mechanism 50 does not interfere with the handle 3, the user can easily operate the handle 3. In addition, the position of the center of gravity of the dual-bearing reel 1 can be stabilized in both the up-down and front-rear directions, thereby improving user operability.

### Modification 3

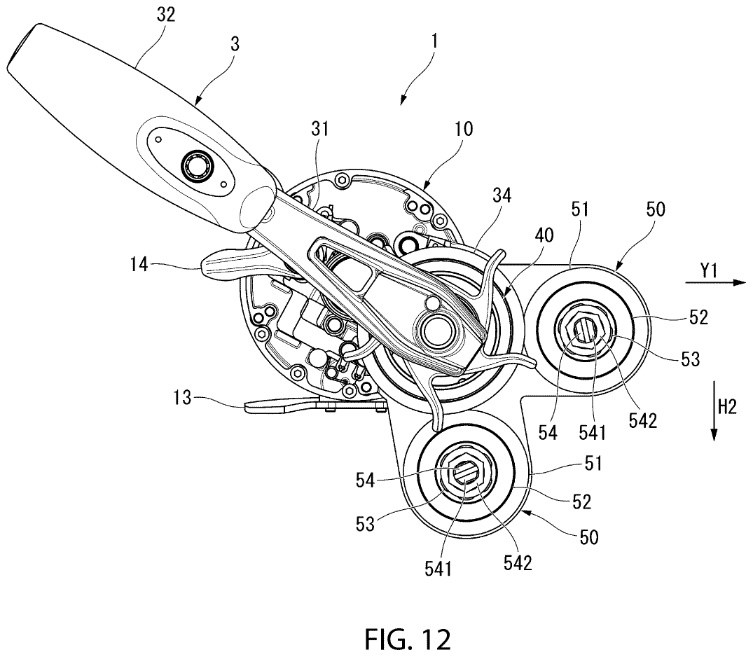

As illustrated in FIG. 12, the dual-bearing reel 1 may include a plurality of second drag mechanisms 50. Specifically, the second drag mechanisms 50 may be disposed in the downward direction H2 with respect to the drive gear 34, and may also be disposed in the forward direction Y1. In the example illustrated in FIG. 12, two second drag mechanisms 50 are provided, but the number of second drag mechanisms 50 is not limited thereto.

With the plurality of second drag mechanisms 50, drag force generated by the plurality of second drag mechanisms 50 can be added to the drag force by the first drag mechanism 40, thereby enabling the dual-bearing reel 1 to be used with higher drag force.

In the dual-bearing reel 1 of the present embodiment, the second drag mechanism 50 includes a second drag adjustment mechanism 54 configured to adjust a frictional force between the drag gear 51 and the drag plate 543, but the configuration of the second drag adjustment mechanism 54 is not limited thereto. For example, the second drag adjustment mechanism 54 may be configured to adjust a frictional force between the reel body 10 and the drag plate 543.

In the dual-bearing reel 1 of the present embodiment, the second drag mechanism 50 is configured such that the adjustment shaft 541 is rotated by a jig, but the configuration of the second drag adjustment mechanism 54 is not limited thereto. For example, the second drag adjustment mechanism 54 may include a knob disposed on the adjustment shaft 541 in the rightward direction X1 such that the adjustment shaft 541 can be rotated by using the knob.

While embodiments of the claimed invention have been described above, these embodiments are presented by way of example and are not intended to limit the scope of the invention. The embodiments can be implemented in various other forms and may undergo various omissions, replacements, or modifications without departing from the spirit of the invention. The embodiments and their variations include, for example, those that can be easily conceived by those skilled in the art, those that are substantially identical, and those that fall within the scope of equivalents.

### REFERENCE SIGNS LIST

1 Dual-bearing reel (Fishing reel)
2 Spool
3 Handle
4 Drag adjustment unit
10 Reel body
10A Right-side frame
10B Left-side frame
11 Connecting frames
12A Right cover member
12B Left cover member
13 Rod mounting unit
14 Clutch operation unit
20 Spool shaft
22 Spool barrel portion
23 Flange
30 Drive shaft
30A Rotation transmission mechanism
31 Handle arm
32 Handle grip
33 Pinion gear shaft
33a Through-hole
34 Drive gear
35 Pinion gear
40 First drag mechanism
42 Stopper gear
43 First drag washer
44 Second drag washer
45 Flat washer
50 Second drag mechanism
51 Drag gear
52 Third drag washer
53 One-way clutch
54 Second drag adjustment mechanism
55 Bearing
56 Spring washer assembly
57a Washer
57b Washer
541 Adjustment shaft
542 Nut
543 Drag plate
544 Engagement portion
545 First friction plate
546 Second friction plate
X Axial direction
X1 Rightward direction
X2 Leftward direction
H2 Downward direction
Y1 Forward direction

What is claimed is:

1. A fishing reel, comprising:
a reel body;
a handle rotatably mounted on the reel body;
a drive shaft configured to rotate integrally with the handle;
a drive gear arranged around the drive shaft;
a first drag mechanism configured to restrict relative rotation between the drive gear and the drive shaft; and
a second drag mechanism configured to restrict rotation of the drive gear relative to the reel body.

2. The fishing reel according to claim 1, wherein the second drag mechanism includes:
a drag gear configured to engage with the drive gear; and
a drag plate disposed between the drag gear and the reel body and configured to restrict rotation of the drive gear relative to the reel body.

3. The fishing reel according to claim 2, wherein the second drag mechanism includes:
an adjustment mechanism configured to adjust either frictional force between the drag gear and the drag plate or frictional force between the reel body and the drag plate.

4. The fishing reel according to claim 2, wherein the second drag mechanism includes:
a one-way clutch that is configured to transmit rotation of the drag gear in a line-winding direction to the drag plate and not to transmit rotation of the drag gear in a line-releasing direction to the drag plate.

5. The fishing reel according to claim 1, wherein
the second drag mechanism is disposed in the downward direction relative to the drive gear.

6. The fishing reel according to claim 1, wherein
the second drag mechanism is disposed in the line-releasing direction relative to the drive gear.

7. The fishing reel according to claim 1, wherein
the fishing reel includes a plurality of the second drag mechanisms.
